(19) United States
(12) Patent Application Publication
(10) Pub. No.: US 2026/0104792 A1
(43) Pub. Date: Apr. 16, 2026

(54) EFFICIENT MEMORY MANAGEMENT FOR BLOOM FILTERS BASED ON INDEX FULLNESS

(71) Applicant: Dell Products L.P., Round Rock, TX (US)

(72) Inventors: Alexander Shknevsky, Fair Lawn, NJ (US); Amit Zaitman, Shavey Shomron (IL); Uri Shabi, Tel Mond (IL)

(21) Appl. No.: 18/915,602

(22) Filed: Oct. 15, 2024

(51) Int. Cl. G06F 3/06

(52) U.S. Cl. CPC G06F 3/0604; G06F 3/0641; G06F 3/0679

(57) ABSTRACT

Techniques for providing efficient memory management for Bloom filters based on index fullness. The techniques include, in each of multiple destaging cycles at an in-memory index level L₁, destaging index entries from a single bucket at L₁ across N buckets at an intermediate on-drive index level L₂, and allocating a Bloom filter for each bucket at L₂ and constructing it based on the index entries in the bucket at L₂, in which the Bloom filter has a size dynamically proportional to a current fullness of the bucket at L₂. The techniques include, in response to an expected fullness of the bucket at L₂ resulting from a next destaging cycle at L₁ being 100%, destaging index entries from the single bucket at L₁ across M buckets at an on-drive index level L₃. The techniques include, destaging the index entries from the N buckets at L₂ across the M buckets at L₃.

### BACKGROUND

Storage systems include storage processors coupled to arrays of storage drives, such as solid state drives (SSDs) and hard disk drives (HDDs). The storage processors receive and service storage input/output (IO) requests (e.g., write requests, read requests) from storage client computers (“storage clients”), which send the storage IO requests to the storage systems over a network. The storage IO requests specify datasets, such as data pages, data blocks, data files, or other data elements, to be written to or read from logical units (LUs), volumes (VOLs), filesystems, or other storage objects maintained on the storage drives. The storage systems perform data reduction processes, including data deduplication (“dedupe”) processes. The storage systems maintain dedupe indexes containing index entries implemented as key-value pairs, in which “key” portions correspond to content-based signatures or digests (e.g., hash values) of datasets and “value” portions correspond to pointers or addresses (e.g., virtual addresses) associated with locations where the datasets are physically stored. In response to a write request specifying a new dataset to be written to a storage object, a hash function is applied to the new dataset to obtain a hash value, and a lookup is performed into a dedupe index to search for an index entry (e.g., key-value pair) including a hash value that matches the obtained hash value. If an index entry is found that includes a matching hash value (e.g., key), then the new dataset is effectively stored using a virtual address (e.g., value) included in the index entry, in which the virtual address corresponds to a previously stored dataset having the same matching hash value. In this way, redundant storage of duplicate datasets is avoided.

### SUMMARY

Storage systems that perform dedupe processes can maintain dedupe indexes across several index levels, including a volatile (“in-memory”) index level and one or more persistent (“on-drive”) index levels. For example, an in-memory index level (“L₁”) may be provided for caching purposes, an on-drive index level (“L₃”) may be provided for hardening large amounts of index entries, and an intermediate on-drive index level (“L₂”), logically disposed between L₁ and L₃, may be provided for amortization purposes. In response to a dedupe index at L₁ reaching a specified fullness threshold or percentage (e.g., about 100%), “dirty” index entries (i.e., index entries not persisted at L₂ or L₃) can be destaged from the dedupe index at L₁ to a dedupe index at L₂. The destaged index entries can be merged with other index entries at L₂, and subsequently deleted or removed from L₁. Having destaged the dirty index entries from L₁ to L₂, the destaged index entries can be marked as “clean”. Once the dedupe index at L₂ reaches a specified fullness threshold or percentage (e.g., about 100%), the index entries at L₂ can be destaged and hardened to storage at L₃.

In one embodiment, dedupe indexes at the in-memory index level L₁, the intermediate on-drive index level L₂, and the on-drive index level L₃, can have sizes defined by predetermined numbers of bucket data structures (“buckets”). For example, a dedupe index at L₁ may have a size defined by a single bucket, a dedupe index at L₂ may have a size defined by an integer multiple (e.g., 4×, 16×) of the number of buckets at L₁, and a dedupe index at L₃ may have a size defined by an integer multiple (e.g., 4×, 16×) of the number of buckets at L₂. As such, the dedupe indexes spread across L₁, L₂, and L₃ can become quite large and consume increasing amounts of memory and/or drive storage space. In-memory Bloom filters can be used to reduce the cost of searching such large dedupe indexes. The reliability of the Bloom filters (e.g., in terms of false positive percentages) can decrease, however, as index entries are added to the dedupe indexes. In addition, as the size of the dedupe indexes increase, the size of the Bloom filters used to search the dedupe indexes can increase and consume more and more memory space.

Techniques are disclosed herein for providing efficient memory management for Bloom filters based on index fullness. The disclosed techniques can be performed in a storage system that implements at least an in-memory index level and an on-drive index level. In one embodiment, the storage system can implement an in-memory index level L₁, an on-drive index level L₃, and an intermediate on-drive index level L₂ logically disposed between L₁ and L₃. For example, a dedupe index at L₁ may have a size defined by a single bucket; a dedupe index at L₂ may have a size defined by a plurality (N) of buckets, in which “N” is an integer multiple (e.g., 4×, 16×) of the single bucket at L₁; and a dedupe index at L₃ may have a size defined by a plurality (M) of buckets, in which “M” is an integer multiple (e.g., 4×, 16×) of the N buckets at L₂. Each bucket of the dedupe indexes at L₁, L₂, and L₃ can have a maximum capacity or fullness defined by a maximum number of index entries (e.g., 200). In the disclosed techniques, the storage system can further implement a plurality of in-memory Bloom filters, each of which can be assigned to a respective bucket at L₂, and conceptually have a maximum possible size (e.g., in terms of a number of bits) that corresponds to the maximum fullness of the respective bucket at L₂.

The disclosed techniques can include, in each of a plurality of destaging cycles at L₁, destaging index entries from the single bucket at L₁ across the N buckets at L₂, allocating, in memory, a Bloom filter for each bucket at L₂, and constructing (or reconstructing) the Bloom filter based on the index entries destaged to the bucket at L₂. The constructed (or reconstructed) Bloom filter can have a size (e.g., in terms of a number of bits) dynamically proportional (e.g., as a fraction or percentage) to a current fullness of the bucket at L₂, assuming substantially even distribution of index entries across the N buckets at L₂. The disclosed techniques can include, in response to an expected fullness of the bucket at L₂ resulting from a next destaging cycle at L₁ being about 100%, destaging and hardening index entries from the single bucket at L₁ across the M buckets at L₃, thereby avoiding having to construct (or reconstruct) a next Bloom filter for each bucket at L₂. The disclosed techniques can include, having destaged the index entries from L₁ to L₃, destaging and hardening the index entries from the N buckets at L₂ across the M buckets at L₃. In one embodiment, the index entries from the single bucket at L₁ and the N buckets at L₂ can be merged in a random access memory (RAM) buffer, and the resulting merged index entries can be written (i.e., hardened) across the M buckets at L₃. As will be described herein in subsequent sections, by optimizing the size (e.g., in terms of a number of bits) of the Bloom filters assigned to the respective buckets at L₂, either a memory consumption of the Bloom filters can be reduced while maintaining a same prior false positive percentage of the Bloom filters, or the false positive percentage of the Bloom filters can be reduced while maintaining the same prior memory consumption of the Bloom filters.

In certain embodiments, a method includes, in each first destaging cycle from among a plurality of first destaging cycles at an in-memory index level (“L₁”), destaging index entries from a bucket data structure (“bucket”) at L₁ across a first plurality of bucket data structures (“buckets”) at an intermediate on-drive index level (“L₂”), allocating, in memory, a Bloom filter for each respective bucket from among the first plurality of buckets at L₂, and constructing the Bloom filter for the respective bucket at L₂ based on index entries contained in the respective bucket at L₂. The Bloom filter has a size dynamically proportional to a current fullness of the respective bucket at L₂ after the first destaging cycle. The method includes, in response to an expected fullness of the respective bucket at L₂ being less than 100% after a next destaging cycle at L₁, destaging index entries from the bucket at L₁ across the first plurality of buckets at L₂, and reconstructing the Bloom filter for the respective bucket at L₂ based on index entries contained in the respective bucket at L₂. The size of the reconstructed Bloom filter is dynamically proportional to the current fullness of the bucket at L₂ after the next destaging cycle.

In certain arrangements, the method includes, in response to the expected fullness of the respective bucket at L₂ being about 100% after the next destaging cycle, destaging and hardening index entries from the bucket at L₁ across a second plurality of buckets at an on-drive index level (“L₃”). L₂ is logically disposed between L₁ and L₃.

In certain arrangements, the method includes destaging and hardening index entries from the first plurality of buckets at L₂ across the second plurality of buckets at L₃.

In certain arrangements, the method includes, having destaged and hardened the index entries from the first plurality of buckets at L₂ across the second plurality of buckets at L₃, deleting or removing the index entries from the first plurality of buckets at L₂.

In certain arrangements, the method includes, having destaged the index entries from the bucket at L₁ across the first plurality of buckets at L₂ or the second plurality of buckets at L₃, deleting or removing the index entries from the bucket at L₁.

In certain arrangements, the method includes, in response to the expected fullness of the respective bucket at L₂ being less than 100% after the next destaging cycle at L₁, clearing and deallocating the Bloom filter for the respective bucket at L₂, and, before reconstructing the Bloom filter for the respective bucket at L₂, allocating, in the memory, the Bloom filter for the respective bucket at L₂.

In certain arrangements, the size of the Bloom filter for the respective bucket at L₂ corresponds to a number of bits in the Bloom filter, and the method includes setting the number (#) of bits in the Bloom filter in accordance with the following equation:

$$\# of bits in Bloom Filter ( B F ) = ( \# of bits in B F for bucket with 100 \% fullness ) * ( current fractional fullness of bucket ) .$$

In certain arrangements, the method includes setting the number (#) of bits in the Bloom filter in accordance with the following equation:

$$\# of bits in Bloom Filter ( B F ) = ( \# of bits in B F for bucket with 100 \% fullness ) * ( current fractional fullness of bucket ) * f ( … ) ,$$

in which “f( . . . )” corresponds to a customizable linear, nonlinear, or constant function pertaining to a desired false positive percentage of the Bloom filter.

In certain embodiments, a system includes a memory, and processing circuitry configured to execute program instructions out of the memory to, in each first destaging cycle from among a plurality of first destaging cycles at an in-memory index level (“L₁”), destage index entries from a bucket data structure (“bucket”) at L₁ across a first plurality of bucket data structures (“buckets”) at an intermediate on-drive index level (“L₂”), allocate, in the memory, a Bloom filter for each respective bucket from among the first plurality of buckets at L₂, and construct the Bloom filter for the respective bucket at L₂ based on index entries contained in the respective bucket at L₂. The Bloom filter has a size dynamically proportional to a current fullness of the respective bucket at L₂ after the first destaging cycle. The processing circuitry is configured to execute the program instructions out of the memory to, in response to an expected fullness of the respective bucket at L₂ being less than 100% after a next destaging cycle at L₁, destage index entries from the bucket at L₁ across the first plurality of buckets at L₂, and reconstruct the Bloom filter for the respective bucket at L₂ based on index entries contained in the respective bucket at L₂. The size of the reconstructed Bloom filter is dynamically proportional to the current fullness of the bucket at L₂ after the next destaging cycle.

In certain arrangements, the processing circuitry is configured to execute the program instructions out of the memory to, in response to the expected fullness of the respective bucket at L₂ being about 100% after the next destaging cycle, destage and harden index entries from the bucket at L₁ across a second plurality of buckets at an on-drive index level (“L₃”). L₂ is logically disposed between L and L₃.

In certain arrangements, the processing circuitry is configured to execute the program instructions out of the memory to destage and harden index entries from the first plurality of buckets at L₂ across the second plurality of buckets at L₃.

In certain arrangements, the processing circuitry is configured to execute the program instructions out of the memory to, having destaged and hardened the index entries from the first plurality of buckets at L₂ across the second plurality of buckets at L₃, delete or remove the index entries from the first plurality of buckets at L₂.

In certain arrangements, the processing circuitry is configured to execute the program instructions out of the memory to, having destaged the index entries from the bucket at L₁ across the first plurality of buckets at L₂ or the second plurality of buckets at L₃, delete or remove the index entries from the bucket at L₁.

In certain arrangements, the processing circuitry is configured to execute the program instructions out of the memory to, in response to the expected fullness of the respective bucket at L₂ being less than 100% after the next destaging cycle at L₁, clear and deallocate the Bloom filter for the respective bucket at L₂, and, before reconstructing the Bloom filter for the respective bucket at L₂, allocate, in the memory, the Bloom filter for the respective bucket at L₂.

In certain arrangements, the size of the Bloom filter for the respective bucket at L₂ corresponds to a number of bits in the Bloom filter. The processing circuitry is configured to execute the program instructions out of the memory to set the number (#) of bits in the Bloom filter in accordance with the following equation:

$$\# of bits in Bloom Filter ( B F ) = ( \# of bits in B F for bucket with 100 \% fullness ) * ( current fractional fullness of bucket ) .$$

In certain arrangements, the processing circuitry is configured to execute the program instructions out of the memory to set the number (#) of bits in the Bloom filter in accordance with the following equation:

$$\# of bits in Bloom Filter ( B F ) = ( \# of bits in B F for bucket with 100 \% fullness ) * ( current fractional fullness of bucket ) * f ( … ) ,$$

in which “f( . . . )” corresponds to a customizable linear, nonlinear, or constant function pertaining to a desired false positive percentage of the Bloom filter.

In certain embodiments, a computer program product includes a set of non-transitory, computer-readable media having program instructions that, when executed by processing circuitry, cause the processing circuitry to perform a method including, in each first destaging cycle from among a plurality of first destaging cycles at an in-memory index level (“L₁”), destaging index entries from a bucket data structure (“bucket”) at L₁ across a first plurality of bucket data structures (“buckets”) at an intermediate on-drive index level (“L₂”), allocating, in memory, a Bloom filter for each respective bucket from among the first plurality of buckets at L₂, and constructing the Bloom filter for the respective bucket at L₂ based on index entries contained in the respective bucket at L₂. The Bloom filter has a size dynamically proportional to a current fullness of the respective bucket at L₂ after the first destaging cycle. The method includes, in response to an expected fullness of the respective bucket at L₂ being less than 100% after a next destaging cycle at L₁, destaging index entries from the bucket at L₁ across the first plurality of buckets at L₂, and reconstructing the Bloom filter for the respective bucket at L₂ based on index entries contained in the respective bucket at L₂. The size of the reconstructed Bloom filter is dynamically proportional to the current fullness of the bucket at L₂ after the next destaging cycle.

Other features, functions, and aspects of the present disclosure will be evident from the Detailed Description that follows.

### BRIEF DESCRIPTION OF THE DRAWINGS

The foregoing and other objects, features, and advantages will be apparent from the following description of particular embodiments of the present disclosure, as illustrated in the accompanying drawings, in which like reference characters refer to the same parts throughout the different views.

FIG. 1 is a block diagram of an exemplary storage environment, in which techniques can be practiced for providing efficient memory management for Bloom filters based on index fullness;

FIG. 2 is a block diagram of an exemplary namespace layer, an exemplary mapping layer, an exemplary virtualization layer, and an exemplary physical layer, each of which can be implemented in the storage environment of FIG. 1;

FIG. 3 is a diagram of an exemplary on-drive data deduplication (“dedupe”) index that can be implemented in the storage environment of FIG. 1, in which the dedupe index contains index entries corresponding to a plurality of bucket data structures (“buckets”);

FIG. 4 is a block diagram of several exemplary index entries corresponding to a bucket of a dedupe index, as well as an exemplary Bloom filter assigned to the bucket;

FIGS. 5a-5d are block diagrams illustrating an exemplary technique for destaging and hardening index entries across a series of index levels that can be practiced in the storage environment of FIG. 1, in which the index levels include an in-memory index level L₁, an on-drive index level L₃, and an intermediate index level L₂ logically disposed between L₁ and L₃; and

FIG. 6 is a flow diagram of an exemplary method of providing efficient memory management for Bloom filters based on index fullness.

### DETAILED DESCRIPTION

Techniques are disclosed herein for providing efficient memory management for Bloom filters based on index fullness. The disclosed techniques can include, in each of a plurality of destaging cycles at an in-memory index level L₁, destaging index entries from a single bucket at L₁ across a plurality (N) of buckets at an intermediate on-drive index level L₂, allocating, in memory, a Bloom filter for each bucket at L₂, and constructing (or reconstructing) the Bloom filter based on the index entries destaged to the bucket at L₂. The constructed (or reconstructed) Bloom filter has a size (e.g., in terms of a number of bits) dynamically proportional to a current fullness of the bucket at L₂, assuming substantially even distribution of index entries across the N buckets at L₂. The disclosed techniques can include, in response to an expected fullness of the bucket at L₂ resulting from a next destaging cycle at L₁ being about 100%, destaging and hardening index entries from the single bucket at L₁ across a plurality (M) of buckets at an on-drive index level L₃, thereby avoiding having to construct (or reconstruct) a next Bloom filter for each bucket at L₂. The disclosed techniques can include, having destaged the index entries from L₁ to L₃, destaging and hardening the index entries from the N buckets at L₂ across the M buckets at L₃. By optimizing the size (e.g., in terms of a number of bits) of the Bloom filters assigned to the respective buckets at L₂, either a memory consumption of the Bloom filters can be reduced while maintaining a same prior false positive percentage of the Bloom filters, or the false positive percentage of the Bloom filters can be reduced while maintaining the same prior memory consumption of the Bloom filters.

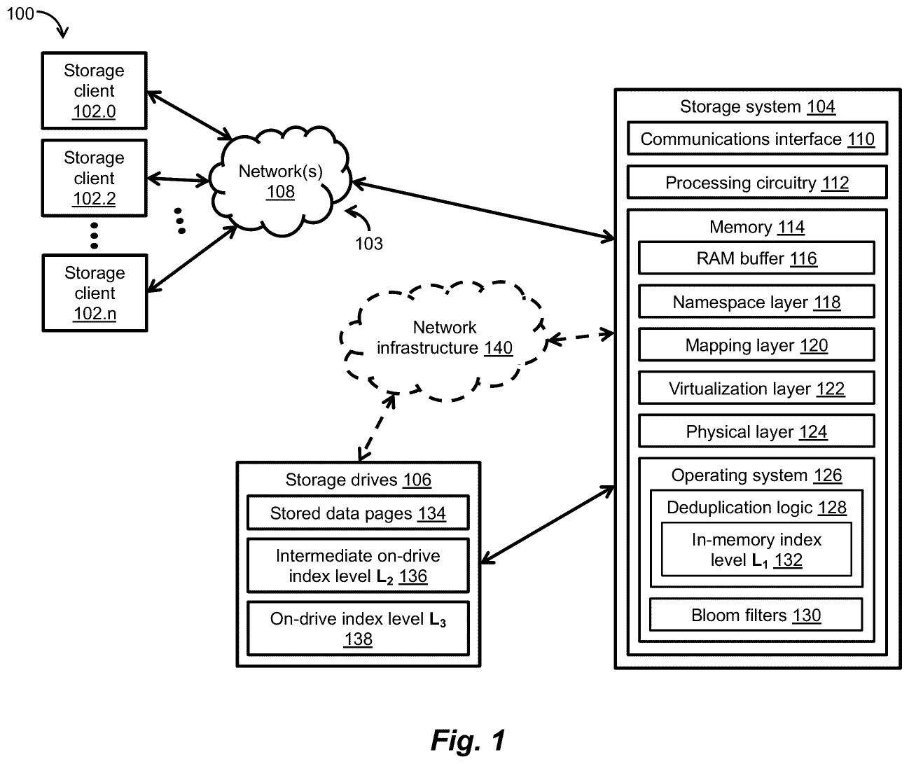

FIG. 1 depicts an illustrative embodiment of an exemplary storage environment 100 for providing efficient memory management for Bloom filters based on index fullness. As shown in FIG. 1, the storage environment 100 can include a plurality of storage client computers (“storage clients”) 102.1, 102.2, . . . , 102.n, a storage system 104, storage drives 106, and a communications medium 103 that includes at least one network 108. Each storage client 102.1, . . . , 102.n can provide, over the network(s) 108, storage input/output (IO) requests (e.g., small computer system interface (SCSI) commands, network file system (NFS) commands) to the storage system 104. Such storage IO requests (e.g., write requests, read requests) can direct the storage system 104 to write or read datasets including data pages, data blocks, data files, or any other suitable data elements to/from logical units (LUs), volumes (VOLs), virtual volumes (VVOLs) (e.g., VMware® VVOLs), filesystems, or any other suitable storage objects maintained on the storage drives (e.g., solid state drives (SSDs), flash drives, hard disk drives (HDDs)) 106.

The communications medium 103 can be configured to interconnect the plurality of storage clients 102.1, . . . , 102.n with the storage system 104, enabling them to communicate and exchange data and control signaling. As shown in FIG. 1, the communications medium 103 can be illustrated as a cloud to represent different network topologies, such as a storage area network (SAN) topology, a network attached storage (NAS) topology, a local area network (LAN) topology, a metropolitan area network (MAN) topology, a wide area network (WAN) topology, and so on. As such, the communications medium 103 can include copper-based communications devices and cabling, fiber optic devices and cabling, wireless devices, and so on, or any suitable combination thereof.

The storage system 104 can be connected either directly to the storage drives 106 or indirectly through an optional network infrastructure 140, which can include an Ethernet network, an InfiniBand network, a Fiber Channel (FC) network, or any other suitable network. As shown in FIG. 1, the storage system 104 can include a communications interface 110, processing circuitry 112, and a memory 114. The communications interface 110 can include an Ethernet interface, an InfiniBand interface, an FC interface, or any other suitable communications interface. The communications interface 110 can further include SCSI target adapters, network interface adapters, or any other suitable adapters, for converting electronic, optical, or wireless signals received over the network(s) 108 to a form suitable for use by the processing circuitry 112. The processing circuitry 112 (e.g., central processing unit (CPU)) can include a set of processing cores (e.g., CPU cores) configured to execute specialized code, modules, and/or logic as program instructions out of the memory 114, process storage IO requests (e.g., write requests, read requests) issued by the storage clients 102.1, . . . , 102.n, and store datasets (e.g., data pages) on the storage drives 106 within the storage environment 100, which can be a RAID (Redundant Array of Independent Disks) environment.

The memory 114 can include volatile memory, such as random access memory (RAM), a RAM buffer 116, and/or any other suitable volatile memory, as well as nonvolatile memory, such as nonvolatile RAM (NVRAM), and/or any other suitable nonvolatile memory. The memory 114 can accommodate a variety of specialized software constructs, including a namespace layer 118, a mapping layer 120, a virtualization layer 122, and a physical layer 124. The memory 114 can also accommodate an operating system (OS) 126, such as a Linux OS, Unix OS, Windows OS, or any other suitable OS, as well as specialized software code, logic, and/or modules, including deduplication (“dedupe”) logic 128 and a plurality of Bloom filters 130. For example, the plurality of Bloom filters 130 may be maintained in ring buffer memory. The dedupe logic 128 can operate on received data pages in association with an in-memory index level L₁ 132. The storage drives 106 can maintain stored data pages 134, an intermediate on-drive index level L₂ 136, and an on-drive index level L₃ 138, on one or more of the storage drives (e.g., SSDs, HDDs) 106.

In one embodiment, dedupe indexes at the in-memory index level L₁ 132, the intermediate on-drive index level L₂ 136, and the on-drive index level L₃ 138 can have sizes defined by predetermined numbers of bucket data structures (“buckets”). For example, a dedupe index at L₁ 132 may have a size defined by a single bucket, or any other suitable size; a dedupe index at L₂ 136 may have a size defined by a plurality (N) of buckets, in which N is an integer multiple (e.g., 4×, 16×) of the single bucket at L₁ 132; and a dedupe index at L₃ 138 may have a size defined by a plurality (M) of buckets, in which M is an integer multiple (e.g., 4×, 16×) of the N buckets at L₂ 136. Each bucket at L₁ 132, L₂ 136, and L₃ 138 can have a maximum capacity or fullness defined by a maximum number of index entries (e.g., 200). In the disclosed techniques, each of the plurality of in-memory Bloom filters 130 can be assigned to a respective bucket at L₂ 136, and conceptually have a maximum possible size (e.g., in terms of a number of bits) that corresponds to the maximum fullness of the respective bucket at L₂ 136. In general, a Bloom filter is a probabilistic data structure that can be used to test whether some element is a member of a set. Elements can be added to the set, but not removed. In addition, false positive matches of elements are permitted, but not false negatives.

The namespace layer 118 can be configured as a logical structure for organizing storage objects, such as LUs, VOLs, VVOLs, filesystems, or any other suitable storage objects. The namespace layer 118 can track logical addresses of the storage objects, including offsets into LUs or file system addresses. In one embodiment, if an LU has a maximum size of 10 gigabytes (GB), then the namespace layer 118 can provide a 10 GB logical address range to accommodate the LU. The mapping layer 120 can be configured as a logical structure for mapping the logical addresses of storage objects in the namespace layer 118 to virtual data structures in the virtualization layer 122. The mapping layer 120 can include a plurality of pointer arrays arranged as multi-level tree data structures (e.g., b-trees), a lowest level of which can include a plurality of leaf pointers.

The virtualization layer 122 can be configured as a logical structure for providing page virtualization in support of data deduplication. The virtualization layer 122 can include an aggregation of virtual large blocks (VLBs), each of which can include a plurality of virtual data structures. Each virtual data structure can contain virtual descriptor information, such as an address (“virtual address”) configured to point to a location of a dataset (e.g., data page) in the physical layer 124, a reference count (“Ref_count”) for keeping track of a number of leaf pointers that point to the virtual data structure, digest (e.g., hash) information, and so on. The physical layer 124 can be configured as a logical structure for storing an aggregation of physical large blocks (PLBs), each of which can accommodate a plurality of compressed or uncompressed datasets (e.g., data pages). Each virtual address can point to a data page in a PLB of the physical layer 124. It is noted that, although the physical layer 124 is described herein using the term “physical”, an underlying one of the storage drives 106 is responsible for the actual physical storage of storage client data.

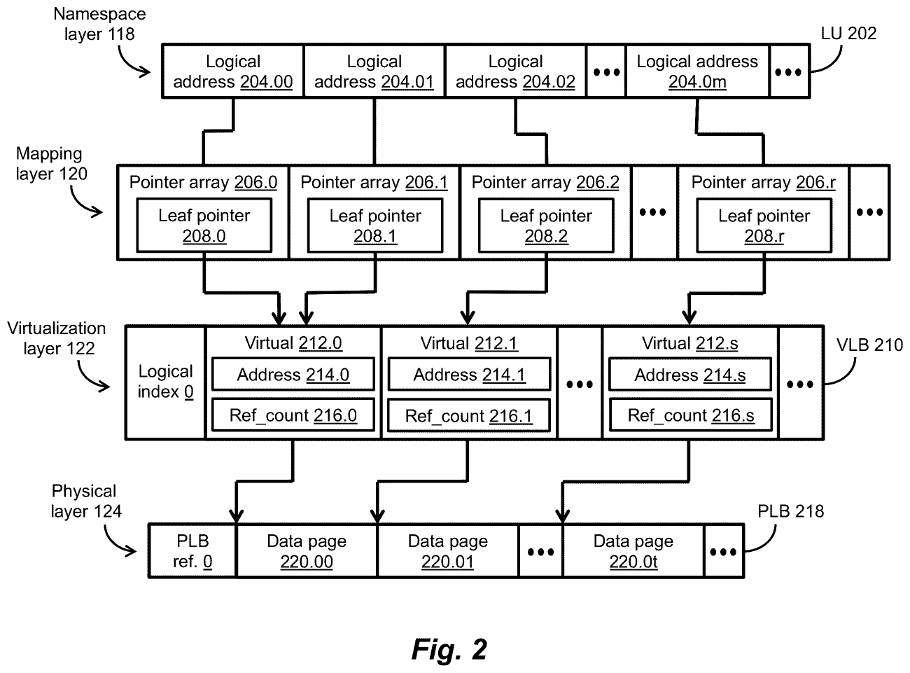

FIG. 2 depicts portions of the namespace layer 118 and the physical layer 124, as well as layers of indirection provided by the mapping layer 120 and the virtualization layer 122. As shown in FIG. 2, the namespace layer 118 can include an LU 202, which can have a logical address 204.00, a logical address 204.01, a logical address 204.02, and so on, up to at least a logical address 204.0m, associated therewith. For example, the logical addresses 204.00, 204.01, . . . , 204.0m, . . . may correspond to contiguous offsets into the LU 202. The virtualization layer 122 can include a VLB 210, which can be associated with a logical index “0”. The VLB 210 can include a virtual data structure (“virtual”) 212.0, a virtual 212.1, and so on, up to at least a virtual 212.s. The mapping layer 120 can include a pointer array 206.0, a pointer array 206.1, a pointer array 206.2, and so on, up to at least a pointer array 206.r. The pointer array 206.0 can include a leaf pointer 208.0, the pointer array 206.1 can include a leaf pointer 208.1, the pointer array 206.2 can include a leaf pointer 208.2, and so on, up to at least the pointer array 206.r, which can include a leaf pointer 208.r. The mapping layer 120 can map the logical addresses 204.00, . . . , 204.0m, . . . of the LU 202 to the virtuals 212.0, . . . , 212.s, . . . of the VLB 210. For example, the leaf pointer 208.0 and the leaf pointer 208.1 may each point to the virtual 212.0, the leaf pointer 208.2 may point to the virtual 212.1, and so on, up to at least the leaf pointer 208.r, which may point to the virtual 212.s. The physical layer 124 can include a PLB 218, which can be associated with a PLB reference (“PLB ref.”) “0”. The PLB 218 can include a data page 220.00, a data page 220.01, and so on, up to at least a data page 220.0t.

To support data deduplication, the virtual 212.0 can contain virtual descriptor information, including an address (“virtual address”) 214.0 and a reference count (“Ref_count”) 216.0, which keeps track of the number of leaf pointers pointing to the virtual 212.0. As shown in FIG. 2, the virtual address 214.0 can be configured to point to a location of the data page 220.00 in the PLB 218. Further, because the two (2) leaf pointers 208.0, 208.1 point to the same virtual 212.0, the Ref_count 216.0 can be equal to “2”. Likewise, the virtual 212.1 can contain virtual descriptor information, including an address (“virtual address”) 214.1 and a reference count (“Ref_count”) 216.1, which keeps track of the number of leaf pointers pointing to the virtual 212.1. As shown in FIG. 2, the virtual address 214.1 can be configured to point to a location of the data page 220.01 in the PLB 218. Further, because only the leaf pointer 208.2 points to the virtual 212.1, the Ref_count 216.1 can be equal to “1”. In addition, the virtual 212.s can contain virtual descriptor information, including an address (“virtual address”) 214.s and a reference count (“Ref_count”) 216.s, which keeps track of the number of leaf pointers pointing to the virtual 212.s. As shown in FIG. 2d, the virtual address 212.s can be configured to point to a location of the data page 220.0t in the PLB 218. Further, because only the leaf pointer 208.r points to the virtual 212.s, the Ref_count 216.s can be equal to “1”.

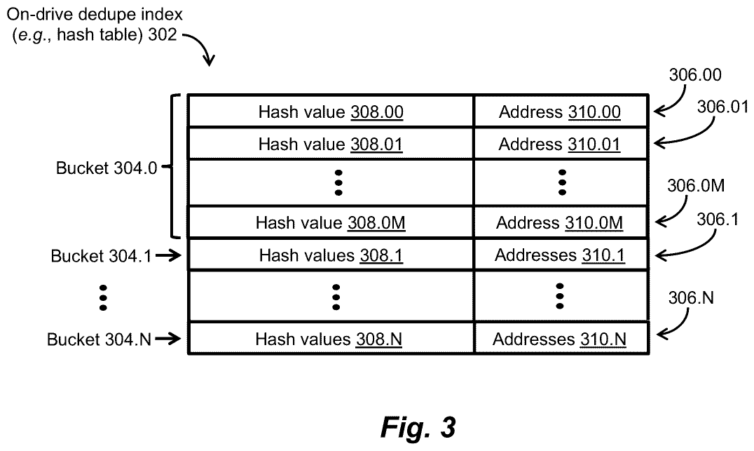

FIG. 3 depicts an exemplary on-drive dedupe index 302. As shown in FIG. 3, the on-drive dedupe index 302 can contain a plurality of index entries, each of which can include a content-based signature or digest (e.g., hash value; SHA-1) of a stored data page, and an address (e.g., virtual address) associated with a location where the data page is stored. As such, the on-drive dedupe index 302 can be implemented as a hash table. In one embodiment, each index entry can be implemented as a key-value pair (e.g., <hash value, virtual address>). For example, an index entry 306.00 may include a hash value 308.00 of a data page, and a virtual address 310.00 associated with a location where the data page is stored; an index entry 306.01 may include a hash value 308.01 of a data page, and a virtual address 310.01 associated with a location where the data page is stored; and so on, up to and including an index entry 306.0M, which may include a hash value 308.0M of a data page, and a virtual address 310.0M associated with a location where the data page is stored. Likewise, index entries 306.1 may include hash values 308.1 of data pages, and virtual addresses 310.1 associated with locations where the data pages are stored, and so on, up to and including index entries 306.N, which may include hash values 308.N of data pages, and virtual addresses 310.N associated with locations where the data pages are stored. The plurality of index entries 306.00-306.0M, 306.1, . . . , 306.N can be assigned to a plurality of buckets 304.0, 304.1, . . . , 304.N. For example, the index entries 306.00, 306.01, . . . , 306.0M may be assigned to the bucket 304.0, the index entries 306.1 may be assigned to the bucket 304.1, and so on, up to and including the index entries 306.N, which may be assigned to the bucket 304.N. It is noted that dedupe indexes like the on-drive dedupe index 302 can be maintained at the intermediate on-drive index level L₂ 136 and the on-drive index level L₃ 138 within the storage environment 100.

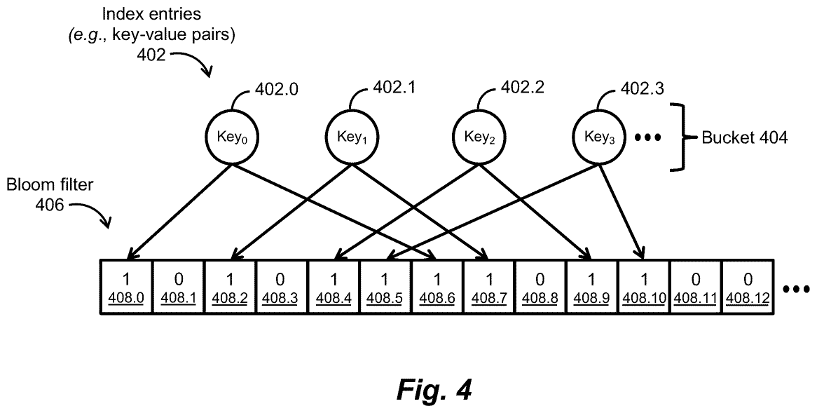

FIG. 4 depicts several exemplary index entries 402, which can correspond to a bucket 404 of a dedupe index, as well as an exemplary Bloom filter 406 assigned to the bucket 404. For example, a Bloom filter like the Bloom filter 406 may be assigned to each bucket 304.0, 304.1, . . . 304.N of the on-drive dedupe index 302. When the need arises to determine whether a dedupe index contains a particular index entry, one or more such Bloom filters can be queried to determine, probabilistically, whether the particular index entry is contained in a bucket of the dedupe index, potentially avoiding having to search the dedupe index directly. Each Bloom filter can return either a positive (or false positive) result or a negative result, but cannot return a false negative result.

As shown in FIG. 4, the index entries 402 corresponding to the bucket 404 can be implemented as key-value pairs (e.g., <hash value, virtual address>). As such, an index entry 402.0 can include a key₀ (e.g., hash value), an index entry 402.1 can include a key₁ (e.g., hash value), an index entry 402.2 can include a key₂ (e.g., hash value), an index entry 402.3 can include a key₃ (e.g., hash value), and so on. The Bloom filter 406 can include a plurality of bit positions 408.0, 408.1, . . . , 408.12, and so on, each of which can store a binary value (e.g., 0 or 1). The number of bit positions (“number of bits”) 408.0, 408.1, . . . , 408.12 can correspond to the “size” of the Bloom filter 406. The Bloom filter 406 can further include a plurality (k) of different hash functions (e.g., k=2, 3), each of which can map an index entry to one of the bit positions 408.0, . . . , 408.12, and so on. Initially, each bit position 408.0, . . . , 408.12, . . . of the Bloom filter 406 is reset to the binary value “0”. When an index entry is added to the bucket 404, the index entry's key is hashed using each of the k different hash functions to obtain k bit positions in the Bloom filter 406, and each of the obtained k bit positions is set to the binary value “1”. For example, assuming the Bloom filter 406 includes two (i.e., k=2) different hash functions, when the index entry 402.0 is added to the bucket 404, the key₀ may be hashed using the two (2) different hash functions to obtain two (2) bit positions in the Bloom filter 406, namely, the bit positions 408.0, 408.6, each of which is set to the binary value “1”. Likewise, when the index entry 402.1 is added to the bucket 404, the key₁ may be hashed using the two (2) different hash functions to obtain the two (2) bit positions 408.2, 408.7, each of which is set to the binary value “1”. When the index entry 402.2 is added to the bucket 404, the key₂ may be hashed using the two (2) different hash functions to obtain the two (2) bit positions 408.4, 408.9, each of which is set to the binary value “1”. When the index entry 402.3 is added to the bucket 404, the key₃ may be hashed using the two (2) different hash functions to obtain the two (2) bit positions 408.5, 408.10, each of which is set to the binary value “1”, and so on.

To test whether a particular index entry is contained in the bucket 404, the index entry's key can be hashed using each of the two (i.e., k=2) hash functions to obtain two (2) bit positions in the Bloom filter 406. If any of the two (2) obtained bit positions stores the binary value “0”, then the Bloom filter 406 can report that the index entry is definitely not contained in the bucket 404. If each of the two (2) obtained bit positions is set to the binary value “1”, then the Bloom filter 406 can report that the index entry is possibly, but not definitely, contained in the bucket 404. It is noted that the “reliability” of a Bloom filter (e.g., in terms of a false positive percentage) can correspond to the probability that (i) an index entry is reported as being possibly contained in a bucket, and (if) the index entry is actually contained in the bucket. The reliability of a Bloom filter can decrease (e.g., the false positive percentage can increase) as index entries are added to the bucket to which it is assigned. It is further noted that a Bloom filter can be configured as a string of bit positions, an array of bit positions, or any other suitable configuration of bit positions.

During operation, the storage system 104 (see FIG. 1) can execute the dedupe logic 128 to implement at least the in-memory index level L₁ 132, the on-drive index level L₃ 138, and the intermediate on-drive index level L₂ 136 logically disposed between L₁ and L₃. For example, a dedupe index at L₁ 132 may have a size defined by a single bucket, or any other suitable size; a dedupe index at L₂ 136 may have a size defined by a plurality (N) of buckets, in which “N” is an integer multiple (e.g., 4×, 16×) of the single bucket at L₁ 132; and a dedupe index at L₃ 138 may have a size defined by a plurality (M) of buckets, in which “M” is an integer multiple (e.g., 4×, 16×) of the N buckets at L₂. Each bucket of the dedupe indexes at L₁ 132, L₂ 136, and L₃ 138 can have a maximum capacity or fullness defined by a maximum number of index entries (e.g., 200). The storage system 104 can implement the plurality of in-memory Bloom filters 130, each of which can be assigned to a respective bucket at L₂ 136, and conceptually have a maximum possible size (e.g., in terms of a number of bits) that corresponds to the maximum fullness of the respective bucket at L₂ 136.

During further operation, the storage system 104 can execute the dedupe logic 128, in each of a plurality of destaging cycles at L₁ 132, to destage index entries from the single bucket at L₁ 132 across the N buckets at L₂ 136, allocate a Bloom filter from among the plurality of in-memory Bloom filters 130 for each bucket at L₂, and construct (or reconstruct) the Bloom filter based on the index entries destaged to the bucket at L₂ 136. The constructed (or reconstructed) Bloom filter can have a size (e.g., in terms of a number of bits) dynamically proportional (e.g., as a fraction or percentage) to a current fullness of the bucket at L₂ 136, assuming substantially even distribution of index entries across the N buckets at L₂ 136. The storage system 104 can execute the dedupe logic 128, in response to an expected fullness of the bucket at L₂ 136 resulting from a next destaging cycle at L₁ 132 being about 100%, to destage and harden index entries from the single bucket at L₁ 132 across the M buckets at L₃ 138, thereby avoiding having to construct (or reconstruct) a next Bloom filter for each bucket at L₂ 136. Having destaged the index entries from L₁ 132 to L₃ 138, the storage system 104 can execute the dedupe logic 128 to destage and harden the index entries from the N buckets at L₂ 136 across the M buckets at L₃ 138. By optimizing the size (e.g., in terms of a number of bits) of the in-memory Bloom filters assigned to the respective buckets at L₂ 136, either a memory consumption of the Bloom filters can be reduced while maintaining a same prior false positive percentage of the Bloom filters, or the false positive percentage of the Bloom filters can be reduced while maintaining the same prior memory consumption of the Bloom filters.

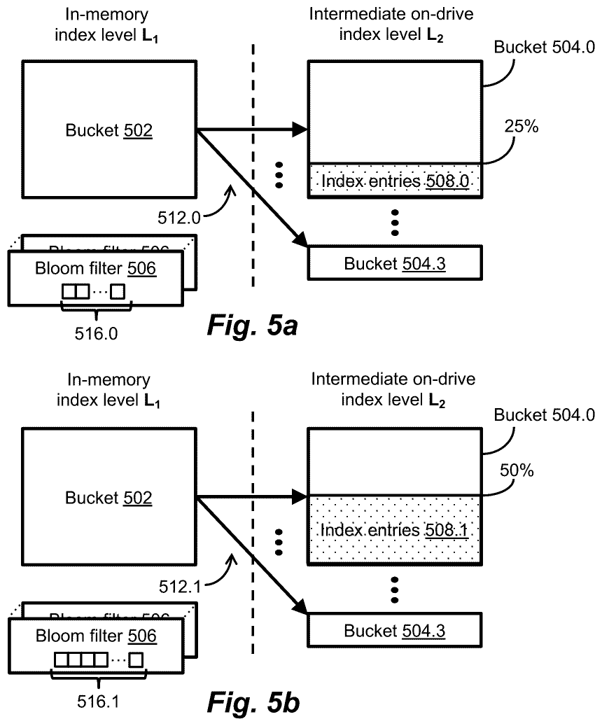

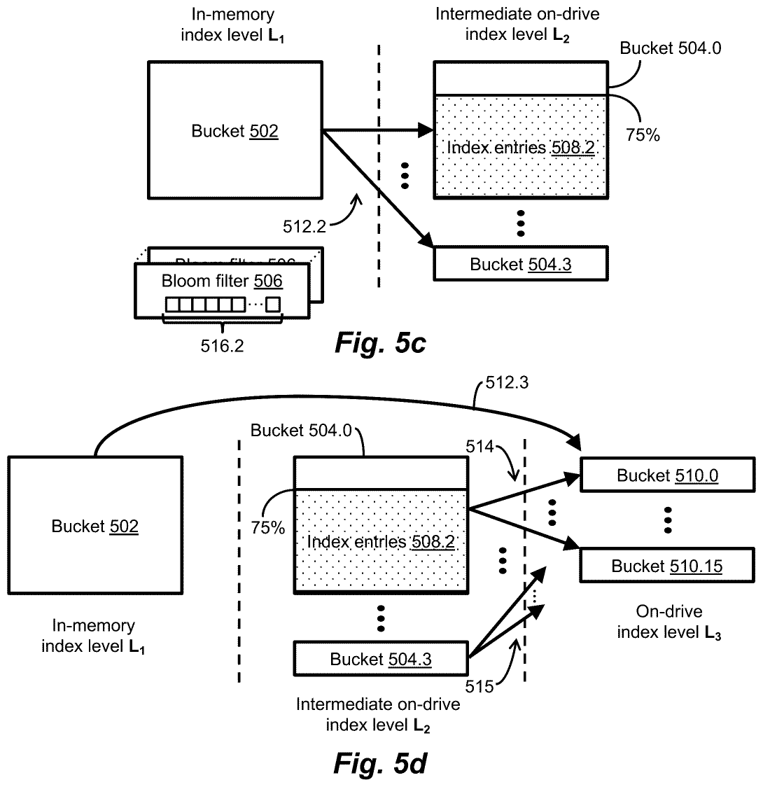

The disclosed techniques for providing efficient memory management for Bloom filters based on index fullness will be further understood with reference to the following illustrative example and FIGS. 5a-5d. In this example, it is assumed that a dedupe index at an in-memory index level L₁ has a size defined by a single bucket 502 (see FIGS. 5a-5d), a dedupe index at an intermediate on-drive index level L₂ has a size defined by four (4) buckets 504.0, . . . , 504.3 (see FIGS. 5a-5d), and a dedupe index at an on-drive index level L₃ has a size defined by sixteen (16) buckets 510.0, . . . , 510.15 (see FIG. 5d). Each bucket at L₁, L₂, and L₃ has a maximum capacity or fullness defined by a maximum number of index entries (e.g., 200), which is rounded to the closest native page size (e.g., 4 kilobytes (KB)). It is further assumed that each of a plurality of Bloom filters 506 (see FIGS. Sa-Sc) at L₁ is assigned to a respective bucket from among the buckets 504.0 . . . , 504.3 at L₂, and conceptually has a maximum possible size that corresponds to the maximum fullness of the respective bucket at L₂.

By querying one or more of the Bloom filters 506 assigned to the respective buckets at L₂, a subsequent search of the buckets at L₃ may be avoided. For example, upon arrival of a new index entry, a determination may be made as to whether or not a duplicate of the new index entry exists in the single bucket at L₁ 132. If a duplicate index entry does not exist in the single bucket at L₁ 132, then one or more of the Bloom filters 506 assigned to the respective buckets at L₂ may be queried to determine whether or not a duplicate index entry possibly exists in one of the buckets at L₂. If a duplicate index entry does not possibly exist in one of the buckets at L₂, then a determination may be made as to whether a duplicate index entry exists in one of the buckets at L₃. Otherwise, if a duplicate index entry possibly exists in one of the buckets at L₂, then a determination may be made as to whether the duplicate index entry actually exists in one of the buckets at L₂, potentially avoiding having to search any of the buckets at L₃.

FIGS. 5a-5d depict a plurality of destaging cycles, in which index entries are destaged from the single bucket 502 at L₁ across the four (4) buckets 504.0, . . . , 504.3 at L₂, and ultimately destaged and hardened across the sixteen (16) buckets 510.0, . . . , 510.15 at L₃. In this example, upon initialization, the Bloom filter ring buffer memory is cleared and deallocated, and each bucket 504.0, . . . , 504.3 at L₂ is empty. In a first destaging cycle, in response to the single bucket 502 at L₁ reaching a specified fullness percentage of about 100%, index entries are destaged from the single bucket 502 across the four (4) buckets 504.0 . . . 504.3 at L₂, as illustrated by paths 512.0 (see FIG. 5a). In one embodiment, when destaging the index entries from the single bucket 502 at L₁, each index entry can be mapped across the buckets 504.0, . . . , 504.3 at L₂ based on a bucket number, a hash value included in the index entry, the size of the dedupe index at L₂, the relative sizes of the dedupe indexes at L₁ and L₂, and/or any other suitable criteria.

In this example, because each bucket at L₁ and L₂ has a maximum capacity or fullness defined by the same maximum number of index entries (e.g., 200), the first destaging of index entries from the single bucket 502 at L₁ across the four (4) buckets 504.0, . . . , 504.3 at L₂ can cause 25% of the maximum fullness of each bucket 504.0, . . . , 504.3 at L₂ to be filled with index entries 508.0 (see FIG. 5a). Having destaged the index entries from the single bucket 502 at L₁, the index entries are deleted or removed from the single bucket 502 at L₁. Further, a Bloom filter 506 (see FIG. 5a) is allocated and assigned to each respective bucket 504.0, . . . , 504.3 at L₂, and constructed based on the index entries 508.0 contained in the respective bucket at L₂. In this example, each Bloom filter 506 is constructed to have the same size (e.g., in terms of a number of bits), which is dynamically proportional (e.g., as a fraction or percentage) to a current fullness of the respective bucket at L₂ to which it is assigned. For example, because, after the first destaging cycle, 25% of the maximum capacity of each respective bucket 504.0, . . . , 504.3 at L₂ is filled with index entries 508.0, the size of the Bloom filter 506 assigned to the respective bucket at L₂ may be set to 25% of its maximum possible size, as represented by a number of bit positions 516.0 (see FIG. 5a).

In a second destaging cycle, in response to the single bucket 502 at L₁ again reaching the specified fullness percentage of about 100%, index entries are destaged from the single bucket 502 across the four (4) buckets 504.0, . . . , 504.3 at L₂, as illustrated by paths 512.1 (see FIG. 5b). Because each bucket at Ly and L₂ has a maximum capacity or fullness defined by the same maximum number of index entries (e.g., 200), the second destaging of index entries from the single bucket 502 at L₁ across the four (4) buckets 504.0, . . . , 504.3 at L₂ can cause 50% of the maximum fullness of each bucket 504.0, . . . , 504.3 at L₂ to be filled with index entries 508.1 (see FIG. 5b). Having destaged the index entries from the single bucket 502 at La, the index entries are deleted or removed from the single bucket 502 at Lt. Further, the Bloom filter 506 assigned to each respective bucket 504.0, . . . , 504.3 at L₂ is reconstructed based on the index entries 508.1 contained in the respective bucket at L₂. In this example, each Bloom filter 506 is reconstructed to have the same size (e.g., in terms of a number of bits), which is dynamically proportional (e.g., as a fraction or percentage) to the current fullness of the respective bucket at L₂ to which it is assigned. For example, because, after the second destaging cycle, 50% of the maximum capacity of each respective bucket 504.0, . . . , 504.3 at L₂ is filled with index entries 508.1, the size of the reconstructed Bloom filter 506 assigned to the respective bucket at L₂ may be set to 50% of its maximum possible size, as represented by an increased number of bit positions 516.1.

In a third destaging cycle, in response to the single bucket 502 again reaching the specified fullness percentage of about 100%, index entries are destaged from the single bucket 502 across the four (4) buckets 504.0, 504.3 at L₂, as illustrated by paths 512.2 (see FIG. 5c). Because each bucket at L₁ and L₂ has a maximum capacity or fullness defined by the same maximum number of index entries (e.g., 200), the third destaging of index entries from the single bucket 502 at L₁ across the four (4) buckets 504.0, . . . , 504.3 at L₂ can cause 75% of the maximum fullness of each bucket 504.0, . . . , 504.3 at L₂ to be filled with index entries 508.2. Having destaged the index entries from the single bucket 502 at L₁, the index entries are deleted or removed from the bucket 502 at L₂. Further, the Bloom filter 506 assigned to each respective bucket 504.0, . . . , 504.3 at L₂ is reconstructed based on the index entries 508.2 contained in the respective bucket at L₂. In this example, each Bloom filter 506 is again reconstructed to have the same size (e.g., in terms of a number of bits), which is dynamically proportional (e.g., as a fraction or percentage) to the current fullness of the respective bucket at L₂ to which it is assigned. For example, because, after the third destaging cycle, 75% of the maximum capacity of each respective bucket 504.0, . . . , 504.3 at L₂ is filled with index entries 508.2, the size of the reconstructed Bloom filter 506 assigned to the respective bucket at L₂ may be set to 75% of its maximum possible size, as represented by a further increased number of bit positions 516.2.

In a fourth destaging cycle, in response to the single bucket 502 again reaching the specified fullness percentage of about 100%, a determination is made regarding an expected fullness of the four (4) buckets 504.0 . . . , 504.3 at L₂ resulting from index entries being destaged from the single bucket 502 at L₁. Because each bucket at L₁ and L₂ has a maximum capacity or fullness defined by the same maximum number of index entries (e.g., 200), the expected fullness of the respective buckets 504.0, . . . , 504.3 at L₂ resulting from the fourth destaging of index entries from the single bucket 502 at L₁ can be about 100%. To avoid reconstructing each Bloom filter 506 to have the same size dynamically proportional (e.g., as a fraction or percentage) to the expected 100% fullness of the respective bucket at L₂ to which it is assigned, the fourth destaging cycle includes destaging and hardening the index entries from the single bucket 502 at L₁ across the sixteen (16) buckets 510.0, . . . , 510.15 at L₃, as illustrated by a path 512.3 (see FIG. 5d). The fourth destaging cycle further includes destaging and hardening the index entries 508.2 from the four (4) buckets 504.0 . . . , 504.3 at L₂ across the sixteen (16) buckets 510.0, . . . , 510.15 at L₃, as illustrated by paths 514, 515 (see FIG. 5d). For example, to avoid any unwanted overwriting of valid index entries contained in the buckets 510.0-510.15 at L₃ while hardening new index entries from L₁ and/or L₂, the valid index entries from L₃ may be copied to the RAM buffer 116 (see FIG. 1), the new index entries from L₁ and/or L₂ may be merged with the valid index entries from L₁ in the RAM buffer 116, and the resulting merged index entries may be written (i.e., hardened) across the buckets 510.0, . . . , 510.15 at L₃. Having destaged and hardened index entries from L₁ and L₂ to the buckets 510.0, . . . , 510.15 at L₃, the index entries are deleted or removed, as appropriate, from the single bucket 502 at L₁ and the four (4) buckets 504.0, 504.3 at L₂.

TABLES I, II, and III below demonstrate several advantages of the disclosed techniques for providing efficient memory management for Bloom filters based on index fullness. Regarding TABLES I, II, and III, it is assumed that dedupe indexes are maintained in the storage system 104 (see FIG. 1) across the in-memory index level L₁ 132, the on-drive index level L₃ 138, and the intermediate on-drive index level L₂ 136, which is logically disposed between L₁ 132 and L₃ 138. It is further assumed that each TABLE I, II, III lists results pertaining to each of four (4) buckets at L₂ after four (4) destaging cycles, in which index entries are destaged from a single bucket at L₁ across the four (4) buckets at L₂.

TABLE I below lists typical results that may be obtained from a prior technique that fails to set the size of Bloom filters assigned to the respective buckets at L₂ in relation to a current fullness of the respective buckets at L₂. In this prior technique, the size (e.g., in terms of a number of bits) of each Bloom filter can be 1100 bits, and the capacity of each bucket at L₂ can accommodate 200 index entries. Specifically, TABLE I lists, for each bucket at L₂, a number of index entries in the bucket at L₂, a false positive (FP) percentage (%) of the Bloom filter assigned to the bucket at L₂, a number (#) of bits in the Bloom filter, and a current fullness percentage (%) of the bucket at L₂. Upon initialization, the Bloom filter ring buffer memory is cleared and deallocated, and each bucket at L₂ is empty. Accordingly, as indicated in the first row of TABLE I, the number of index entries in the bucket at L₂ is “0”, the FP % of the Bloom filter assigned to the bucket at L₂ is “0.00%”, the # of bits in the Bloom filter is “1100”, and the current fullness % of the bucket at L₂ is “0%”.

TABLE I

| Number of | False Positive | Number (#) | |
|---|---|---|---|
| Index Entries | (FP) | of bits | Bucket fullness |
| in Bucket at L₂ | percentage (%) | in Bloom Filter | percentage (%) |
| 0 | 0.00% | 1100 | 0% |
| 50 | 0.76% | 1100 | 25% |
| 100 | 2.76% | 1100 | 50% |
| 150 | 5.70% | 1100 | 75% |
| 200 | 9.29% | 1100 | 100% |
| | Average | | |
| | FP %: 3.70% | | |

In a first destaging cycle, in response to the single bucket at L₁ reaching a specified fullness percentage of about 100%, 200 index entries are destaged from the single bucket at L₁ across the four (4) buckets at L₂. As a result, as indicated in the second row of TABLE I, the number of index entries in the bucket at L₂ is “50”, the FP % of the Bloom filter assigned to the bucket at L₂ is “0.76%”, the # of bits in the Bloom filter is “1100”, and the current fullness % of the bucket at L₂ is “25%”. In a second destaging cycle, in response to the single bucket at L₁ again reaching the specified fullness percentage of about 100%, 200 index entries are destaged from the single bucket at L₁ across the four (4) buckets at L₂. As a result, as indicated in the third row of TABLE I, the number of index entries in the bucket at L₂ is “100”, the FP % of the Bloom filter assigned to the bucket at L₂ is “2.76%”, the # of bits in the Bloom filter is “1100”, and the current fullness % of the bucket at L₂ is “50%”.

In a third destaging cycle, in response to the single bucket at L₁ again reaching the specified fullness percentage of about 100%, 200 index entries are destaged from the single bucket at L₁ across the four (4) buckets at L₂. As a result, as indicated in the fourth row of TABLE I, the number of index entries in the bucket at L₂ is “150”, the FP % of the Bloom filter assigned to the bucket at L₂ is “5.70%”, the # of bits in the Bloom filter is “1100”, and the current fullness % of the bucket at L₂ is “75%”. Finally, in a fourth destaging cycle, in response to the single bucket at L₁ again reaching the specified fullness percentage of about 100%, 200 index entries are destaged from the single bucket at L₁ across the four (4) buckets at L₂. As a result, as indicated in the fifth row of TABLE I, the number of index entries in the bucket at L₂ is “200”, the FP % of the Bloom filter assigned to the bucket at L₂ is “9.29%”, the # of bits in the Bloom filter is “1100”, and the current fullness % of the bucket at L₂ is about “100%” (at which point the index entries can be destaged and hardened from the four (4) buckets at L₂ across a plurality of buckets at L₃). As indicated in TABLE I, as the number of index entries in the bucket at L₂ increases from “0” to “200”, the FP % of the Bloom filter assigned to the bucket at L₂ increases from “0.00%” to “9.29%”, with an average FP % of 3.70%.

TABLE II lists exemplary results that may be obtained from the disclosed technique, in which the Bloom filters assigned to the four (4) buckets at L₂ are constructed (or reconstructed), after each destaging cycle, to have a size (e.g., in terms of a number of bits) dynamically proportional (e.g., as a fraction or percentage) to a current fullness of the buckets at L₂. Upon initialization, the Bloom filter ring buffer memory is cleared and deallocated, and each bucket at L₂ is empty. Accordingly, as indicated in the first row of TABLE II, the number of index entries in the bucket at L₂ is “0”, the FP % of the Bloom filter assigned to the bucket at L₂ is “0.00%”, the # of bits in the Bloom filter is “0”, and the current fullness % of the bucket at L₂ is 0%.

TABLE II

| Number of | False Positive | Number (#) | |
|---|---|---|---|
| Index Entries | (FP) | of bits in | Bucket fullness |
| in Bucket | percentage (%) | Bloom Filter | percentage (%) |
| 0 | 0.00% | 0 | 0% |
| 50 | 4.94% | 398 | 25% |
| 100 | 4.94% | 796 | 50% |
| 150 | 4.94% | 1193 | 75% |
| | Average | Average # | |
| | FP %: 3.70% | of bits: 597 | |

In a first destaging cycle, in response to the single bucket at L₁ reaching a specified fullness percentage of about 100%, 200 index entries are destaged from the single bucket at L₁ across the four (4) buckets at L₂. As a result, as indicated in the second row of TABLE II, the number of index entries in the bucket at L₂ is “50”, the FP % of the Bloom filter assigned to the bucket at L₂ is “4.94%”, the # of bits in the Bloom filter is “398”, and the current fullness % of the bucket at L₂ is “25%”. In a second destaging cycle, in response to the single bucket at L₁ again reaching the specified fullness percentage of about 100%, 200 index entries are destaged from the single bucket at L₁ across the four (4) buckets at L₂. As a result, as indicated in the third row of TABLE II, the number of index entries in the bucket at L₂ is “100”, the FP % of the Bloom filter assigned to the bucket at L₂ is “4.94%”, the # of bits in the Bloom filter is “796”, and the current fullness % of the bucket at L₂ is “50%”.

In a third destaging cycle, in response to the single bucket at L₁ again reaching the specified fullness percentage of about 100%, 200 index entries are destaged from the single bucket at L₁ across the four (4) buckets at L₂. As a result, as indicated in the fourth row of TABLE II, the number of index entries in the bucket at L₂ is “150”, the FP % of the Bloom filter assigned to the bucket at L₂ is “4.94%”, the # of bits in the Bloom filter is “1193”, and the current fullness % of the bucket at L₂ is “75%”. In a fourth destaging cycle, in response to (i) the single bucket at L₁ again reaching the specified fullness percentage of about 100%, and (ii) the expected fullness of the four (4) buckets at L₂ being about 100%, 200 index entries are destaged and hardened from the single bucket at L₁ across the plurality of buckets at L₃. In addition, 600 index entries are destaged and hardened from the four (4) buckets at L₂ (each of which contains 150 index entries) across the plurality of buckets at L₃.

As indicated in TABLE II, as the number of index entries in the bucket at L₂ increases from “0” to “150”, (i) the FP % of the Bloom filter assigned to the bucket at L₂ increases from “0.00%” to “4.94%”, with an average FP % of “3.70%”, and (ii) the # of bits in the Bloom filter increases from “0” to “1193”, with an average # of bits in the Bloom filter of “597”. As a result, the memory consumption of the Bloom filter assigned to the bucket at L₂ is reduced from 1100 bits in the prior technique to an average of 597 bits in the disclosed technique, while maintaining the same prior FP % (on average) of the Bloom filter, namely, 3.70%. In general, the # of bits in the Bloom filter assigned to the bucket at L₂ can be expressed, as follows:

$$\# of bits in Bloom Filter ( B F ) = ( \# of bits in B F for bucket with 100 \% fullness ) * ( current fractional fullness of bucket ) \qquad ( 1 )$$

in which, for the exemplary results listed in TABLE II, the “# of bits in BF for bucket with 100% fullness” can be equal to about 1591 bits, and the “current fractional fullness of bucket” can be equal to 0.00 (i.e., 0%), 0.25 (i.e., 25%), 0.50 (i.e., 50%), or 0.75 (i.e., 75%).

TABLE III lists additional exemplary results that may be obtained from the disclosed technique, in which the Bloom filters assigned to the four (4) buckets at L₂ are again constructed (or reconstructed), after each destaging cycle, to have a size (e.g., in terms of a number of bits) dynamically proportional (e.g., as a fraction or percentage) to a current fullness of the buckets at L₂. Upon initialization, the Bloom filter ring buffer memory is cleared and deallocated, and each bucket at L₂ is empty. Accordingly, as indicated in the first row of TABLE III, the number of index entries in the bucket at L₂ is “0”, the FP % of the Bloom filter assigned to the bucket at L₂ is “0.00%”, the # of bits in the Bloom filter is “0”, and the current fullness % of the bucket at L₂ is 0%.

TABLE III

| Number of | False Positive | Number (#) | |
|---|---|---|---|
| Index Entries | (FP) | of bits in | Bucket fullness |
| in Bucket | percentage (%) | Bloom Filter | percentage (%) |
| 0 | 0.00% | 0 | 0% |
| 50 | 1.62% | 735 | 25% |
| 100 | 1.63% | 1466 | 50% |
| 150 | 1.63% | 2199 | 75% |
| | Average | Average # | |
| | FP %: 1.22% | of bits: 1100 | |

In a first destaging cycle, in response to the single bucket at L₁ reaching a specified fullness percentage of about 100%, 200 index entries are destaged from the single bucket at L₁ across the four (4) buckets at L₂. As a result, as indicated in the second row of TABLE III, the number of index entries in the bucket at L₂ is “50”, the FP % of the Bloom filter assigned to the bucket at L₂ is “1.62%”, the # of bits in the Bloom filter is “735”, and the current fullness % of the bucket at L₂ is “25%”. In a second destaging cycle, in response to the single bucket at L₁ again reaching the specified fullness percentage of about 100%, 200 index entries are destaged from the single bucket at L₁ across the four (4) buckets at L₂. As a result, as indicated in the third row of TABLE III, the number of index entries in the bucket at L₂ is “100”, the FP % of the Bloom filter assigned to the bucket at L₂ is “1.63%”, the # of bits in the Bloom filter is “1466”, and the current fullness % of the bucket at L₂ is “50%”.

In a third destaging cycle, in response to the single bucket at L₁ again reaching the specified fullness percentage of about 100%, 200 index entries are destaged from the single bucket at L₁ across the four (4) buckets at L₂. As a result, as indicated in the fourth row of TABLE III, the number of index entries in the bucket at L₂ is “150”, the FP % of the Bloom filter assigned to the bucket at L₂ is “1.63%”, the # of bits in the Bloom filter is “2199”, and the current fullness % of the bucket at L₂ is “75%”. In a fourth destaging cycle, in response to (i) the single bucket at L₁ again reaching the specified fullness percentage of about 100%, and (ii) the expected fullness of the four (4) buckets at L₂ being about 100%, 200 index entries are destaged and hardened from the single bucket at L₁ across the plurality of buckets at L₃. In addition, 600 index entries are destaged and hardened from the four (4) buckets at L₂ (each of which contains 150 index entries) across the plurality of buckets at L₃.

As indicated in TABLE III, as the number of index entries in the bucket at L₂ increases from “0” to “150”, (i) the FP % of the Bloom filter assigned to the bucket at L₂ increases from “0.00%” to “1.63%”, with an average FP % of “1.22%”, and (ii) the # of bits in the Bloom filter is increased from “0” to “2199”, with an average # of bits in the Bloom filter of 1100. As a result, the FP % of the Bloom filter assigned to the bucket at L₂ is reduced from an average of 3.70% in the prior technique to an average of 1.22% in the disclosed technique, while maintaining the same prior memory consumption (on average) of the Bloom filter, namely, 1100 bits. In one embodiment, the # of bits in the Bloom filter can be expressed, as follows:

$$\# of bits in Bloom Filter ( B F ) = ( \# of bits in B F for bucket with 100 \% fullness ) * ( current fractional fullness of bucket ) * f ( … ) , \qquad ( 2 )$$

in which, for the exemplary results listed in TABLE III, the “# of bits in BF for bucket with 100% fullness” can be equal to about 2934 bits, the “current fractional fullness of bucket” can be equal to 0.00 (i.e., 0%), 0.25 (i.e., 25%), 0.50 (i.e., 50%), or 0.75 (i.e., 75%), and “f( . . . )” can correspond to a customizable linear, nonlinear, or constant function pertaining to a desired FP % of the Bloom filter assigned to the bucket at L₂. By incorporating the customizable function, f( . . . ), in equation (2), an acceptable tradeoff between the goals of reducing the FP % of Bloom filters, and reducing the memory consumption of the Bloom filters, may be achieved more easily.

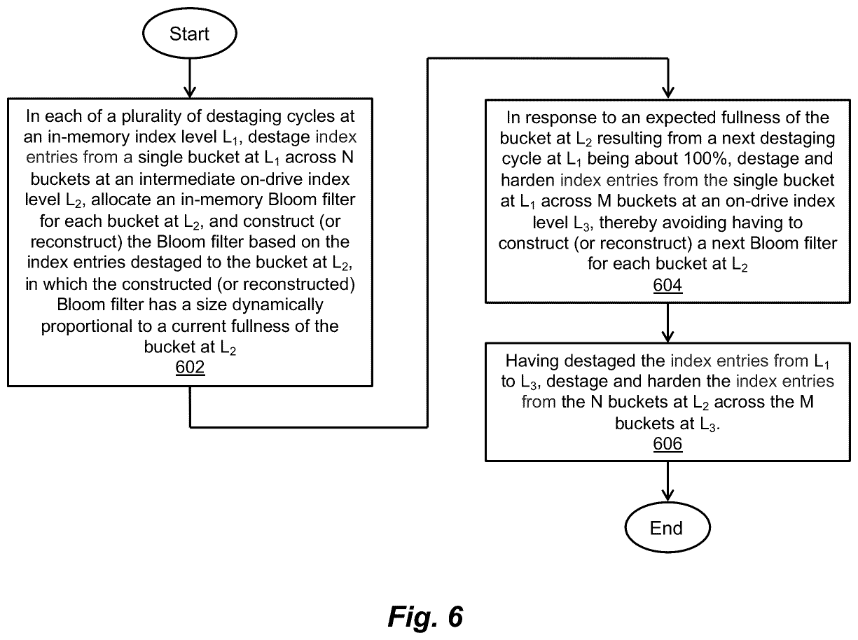

A method of providing efficient memory management for Bloom filters based on index fullness is described below with reference to FIG. 6. As shown in block 602, in each of a plurality of destaging cycles at an in-memory index level L₁, index entries are destaged from a single bucket at L₁ across N buckets at an intermediate on-drive index level L₂, a Bloom filter is allocated, in memory, for each bucket at L₂, and the Bloom filter is constructed (or reconstructed) based on the index entries destaged to the bucket at L₂, in which the constructed (or reconstructed) Bloom filter has a size dynamically proportional to a current fullness of the bucket at L₂. As shown in block 604, in response to an expected fullness of the bucket at L₂ resulting from a next destaging cycle at L₁ being about 100%, index entries are destaged and hardened from the single bucket at L₁ across M buckets at an on-drive index level L₃, thereby avoiding having to construct (or reconstruct) a next Bloom filter for each bucket at L₂. As shown in block 606, having destaged the index entries from L₁ to L₃, the index entries are destaged and hardened from the N buckets at L₂ across the M buckets at L₃.

Several definitions of terms are provided below for the purpose of aiding the understanding of the foregoing description, as well as the claims set forth herein.

As employed herein, the term “storage system” is intended to be broadly construed to encompass, for example, private or public cloud computing systems for storing data, as well as systems for storing data comprising virtual infrastructure and those not comprising virtual infrastructure.

As employed herein, the terms “client,” “host,” and “user” refer, interchangeably, to any person, system, or other entity that uses a storage system to read/write data.

As employed herein, the term “storage device” may refer to a storage array including multiple storage devices. Such a storage device may refer to any non-volatile memory (NVM) device, including hard disk drives (HDDs), solid state drives (SSDs), flash devices (e.g., NAND flash devices, NOR flash devices), and/or similar devices that may be accessed locally and/or remotely, such as via a storage area network (SAN).

As employed herein, the term “storage array” may refer to a storage system used for block-based, file-based, or other object-based storage. Such a storage array may include, for example, dedicated storage hardware containing HDDs, SSDs, and/or all-flash drives.

As employed herein, the term “storage entity” may refer to a filesystem, an object storage, a virtualized device, a logical unit (LUN), a logical volume (LV), a logical device, a physical device, and/or a storage medium.

As employed herein, the term “LUN” may refer to a logical entity provided by a storage system for accessing data from the storage system and may be used interchangeably with a logical volume (LV). The term “LUN” may also refer to a logical unit number for identifying a logical unit, a virtual disk, or a virtual LUN.

As employed herein, the term “physical storage unit” may refer to a physical entity such as a storage drive or disk or an array of storage drives or disks for storing data in storage locations accessible at addresses. The term “physical storage unit” may be used interchangeably with the term “physical volume.”

As employed herein, the term “storage medium” may refer to a hard drive or flash storage, a combination of hard drives and flash storage, a combination of hard drives, flash storage, and other storage drives or devices, or any other suitable types and/or combinations of computer readable storage media. Such a storage medium may include physical and logical storage media, multiple levels of virtual-to-physical mappings, and/or disk images. The term “storage medium” may also refer to a computer-readable program medium.

As employed herein, the term “IO request” or “IO” may refer to a data input or output request such as a read request or a write request.

As employed herein, the terms, “such as,” “for example,” “e.g.,” “exemplary,” and variants thereof refer to non-limiting embodiments and have meanings of serving as examples, instances, or illustrations. Any embodiments described herein using such phrases and/or variants are not necessarily to be construed as preferred or more advantageous over other embodiments, and/or to exclude incorporation of features from other embodiments.

As employed herein, the term “optionally” has a meaning that a feature, element, process, etc., may be provided in certain embodiments and may not be provided in certain other embodiments. Any particular embodiment of the present disclosure may include a plurality of optional features unless such features conflict with one another.

While various embodiments of the present disclosure have been particularly shown and described, it will be understood by those skilled in the art that various changes in form and details may be made therein without departing from the scope of the present disclosure, as defined by the appended claims.

What is claimed is:

1. A method comprising:
in each first destaging cycle from among a plurality of first destaging cycles at an in-memory index level (“L₁”), destaging index entries from a bucket data structure (“bucket”) at L₁ across a first plurality of bucket data structures (“buckets”) at an intermediate on-drive index level (“L₂”);
allocating, in memory, a Bloom filter for each respective bucket from among the first plurality of buckets at L₂;
constructing the Bloom filter for the respective bucket at L₂ based on index entries contained in the respective bucket at L₂, the Bloom filter having a size dynamically proportional to a current fullness of the respective bucket at L₂ after the first destaging cycle;
and
in response to an expected fullness of the respective bucket at L₂ being less than 100% after a next destaging cycle at L₁:
in the next destaging cycle, destaging index entries from the bucket at L₁ across the first plurality of buckets at L₂; and
reconstructing the Bloom filter for the respective bucket at L₂ based on index entries contained in the respective bucket at L₂, the size of the Bloom filter being dynamically proportional to the current fullness of the bucket at L₂ after the next destaging cycle.

2. The method of claim 1 further comprising:
in response to the expected fullness of the respective bucket at L₂ being about 100% after the next destaging cycle:
in the next destaging cycle, destaging and hardening index entries from the bucket at L₁ across a second plurality of buckets at an on-drive index level (“L₃”), L₂ being logically disposed between L₁ and L₃.

3. The method of claim 2 comprising:
destaging and hardening index entries from the first plurality of buckets at L₂ across the second plurality of buckets at L₃.

4. The method of claim 3 comprising:
having destaged and hardened the index entries from the first plurality of buckets at L₂ across the second plurality of buckets at L₃, deleting or removing the index entries from the first plurality of buckets at L₂.

5. The method of claim 2 comprising:
having destaged the index entries from the bucket at L₁ across the first plurality of buckets at L₂ or the second plurality of buckets at L₃, deleting or removing the index entries from the bucket at L₁.

6. The method of claim 1 comprising:
in response to the expected fullness of the respective bucket at L₂ being less than 100% after the next destaging cycle at L₁:
clearing and deallocating the Bloom filter for the respective bucket at L₂; and
before reconstructing the Bloom filter for the respective bucket at L₂, allocating, in the memory, the Bloom filter to be reconstructed for the respective bucket at L₂.

7. The method of claim 1 wherein the size of the Bloom filter for the respective bucket at L₂ corresponds to a number of bits in the Bloom filter, and wherein the method comprises:
setting the number (#) of bits in the Bloom filter in accordance with the following equation:
$$\# of bits in Bloom Filter ( B F ) = ( \# of bits in B F for bucket with 100 \% fullness ) * ( current fractional fullness of bucket ) .$$

8. The method of claim 1 wherein the size of the Bloom filter for the respective bucket at L₂ corresponds to a number of bits in the Bloom filter, and wherein the method comprises:
setting the number (#) of bits in the Bloom filter in accordance with the following equation:
$$\# of bits in Bloom Filter ( B F ) = ( \# of bits in B F for bucket with 100 \% fullness ) * ( current fractional fullness of bucket ) * f ( … ) ,$$
wherein “f( . . . )” corresponds to a customizable linear, nonlinear, or constant function pertaining to a desired false positive percentage of the Bloom filter.

9. A system comprising:
a memory; and
processing circuitry configured to execute program instructions out of the memory to:
in each first destaging cycle from among a plurality of first destaging cycles at an in-memory index level (“L₁”), destage index entries from a bucket data structure (“bucket”) at L₁ across a first plurality of bucket data structures (“buckets”) at an intermediate on-drive index level (“L₂”);
allocate, in the memory, a Bloom filter for each respective bucket from among the first plurality of buckets at L₂;
construct the Bloom filter for the respective bucket at L₂ based on index entries contained in the respective bucket at L₂,
wherein the Bloom filter has a size dynamically proportional to a current fullness of the respective bucket at L₂ after the first destaging cycle; and
in response to an expected fullness of the respective bucket at L₂ being less than 100% after a next destaging cycle at L₁:
in the next destaging cycle, destage index entries from the bucket at L₁ across the first plurality of buckets at L₂; and
reconstruct the Bloom filter for the respective bucket at L₂ based on index entries contained in the respective bucket at L₂,
wherein the size of the Bloom filter is dynamically proportional to the current fullness of the bucket at L₂ after the next destaging cycle.

10. The system of claim 9 wherein the processing circuitry is configured to execute the program instructions out of the memory to:
in response to the expected fullness of the respective bucket at L₂ being about 100% after the next destaging cycle:
in the next destaging cycle, destage and harden index entries from the bucket at L₁ across a second plurality of buckets at an on-drive index level (“L₃”),
wherein L₂ is logically disposed between L₁ and L₃.

11. The system of claim 10 wherein the processing circuitry is configured to execute the program instructions out of the memory to destage and harden index entries from the first plurality of buckets at L₂ across the second plurality of buckets at L₃.

12. The system of claim 11 wherein the processing circuitry is configured to execute the program instructions out of the memory to:
having destaged and hardened the index entries from the first plurality of buckets at L₂ across the second plurality of buckets at L₃, delete or remove the index entries from the first plurality of buckets at L₂.

13. The system of claim 10 wherein the processing circuitry is configured to execute the program instructions out of the memory to:
having destaged the index entries from the bucket at L₁ across the first plurality of buckets at L₂ or the second plurality of buckets at L₃, delete or remove the index entries from the bucket at L₁.

14. The system of claim 9 wherein the processing circuitry is configured to execute the program instructions out of the memory to:
in response to the expected fullness of the respective bucket at L₂ being less than 100% after the next destaging cycle at L₁:
clear and deallocate the Bloom filter for the respective bucket at L₂; and
before reconstructing the Bloom filter for the respective bucket at L₂, allocate, in the memory, the Bloom filter to be reconstructed for the respective bucket at L₂.

15. The system of claim 9 wherein the size of the Bloom filter for the respective bucket at L₂ corresponds to a number of bits in the Bloom filter, and wherein the processing circuitry is configured to execute the program instructions out of the memory to:
set the number (#) of bits in the Bloom filter in accordance with the following equation:
$$\# of bits in Bloom Filter ( B F ) = ( \# of bits in B F for bucket with 100 \% fullness ) * ( current fractional fullness of bucket ) .$$

16. The system of claim 9 wherein the size of the Bloom filter for the respective bucket at L₂ corresponds to a number of bits in the Bloom filter, and wherein the processing circuitry is configured to execute the program instructions out of the memory to:
set the number (#) of bits in the Bloom filter in accordance with the following equation:
$$\# of bits in Bloom Filter ( B F ) = ( \# of bits in B F for bucket with 100 \% fullness ) * ( current fractional fullness of bucket ) * f ( … ) ,$$
wherein “f( . . . )” corresponds to a customizable linear, nonlinear, or constant function pertaining to a desired false positive percentage of the Bloom filter.

17. A computer program product including a set of non-transitory, computer-readable media having program instructions that, when executed by processing circuitry, cause the processing circuitry to perform a method comprising:
in each first destaging cycle from among a plurality of first destaging cycles at an in-memory index level (“L₁”), destaging index entries from a bucket data structure (“bucket”) at L₁ across a first plurality of bucket data structures (“buckets”) at an intermediate on-drive index level (“L₂”);
allocating, in memory, a Bloom filter for each respective bucket from among the first plurality of buckets at L₂;
constructing the Bloom filter for the respective bucket at L₂ based on index entries contained in the respective bucket at L₂, the Bloom filter having a size dynamically proportional to a current fullness of the respective bucket at L₂ after the first destaging cycle;
and
in response to an expected fullness of the respective bucket at L₂ being less than 100% after a next destaging cycle at L₁:
in the next destaging cycle, destaging index entries from the bucket at L₁ across the first plurality of buckets at L₂; and
reconstructing the Bloom filter for the respective bucket at L₂ based on index entries contained in the respective bucket at L₂, the size of the Bloom filter being dynamically proportional to the current fullness of the bucket at L₂ after the next destaging cycle.

18. The computer program product of claim 17 wherein the method comprises:
in response to the expected fullness of the respective bucket at L₂ being about 100% after the next destaging cycle:
in the next destaging cycle, destaging and hardening index entries from the bucket at L₁ across a second plurality of buckets at an on-drive index level (“L₃”), L₂ being logically disposed between L₁ and L₃; and
destaging and hardening index entries from the first plurality of buckets at L₂ across the second plurality of buckets at L₃.

19. The computer program product of claim 17 wherein the size of the Bloom filter for the respective bucket at L₂ corresponds to a number of bits in the Bloom filter, and wherein the method comprises:
setting the number (#) of bits in the Bloom filter in accordance with the following equation:
$$\# of bits in Bloom Filter ( B F ) = ( \# of bits in B F for bucket with 100 \% fullness ) * ( current fractional fullness of bucket ) .$$

20. The computer program product of claim 17 wherein the size of the Bloom filter for the respective bucket at L₂ corresponds to a number of bits in the Bloom filter, and wherein the method comprises:
setting the number (#) of bits in the Bloom filter in accordance with the following equation:
$$\# of bits in Bloom Filter ( B F ) = ( \# of bits in B F for bucket with 100 \% fullness ) * ( current fractional fullness of bucket ) * f ( … ) ,$$
wherein “f( . . . )” corresponds to a customizable linear, nonlinear, or constant function pertaining to a desired false positive percentage of the Bloom filter.
